(19) United States
(12) Patent Application Publication
(10) Pub. No.: US 2017/0359729 A1
(43) Pub. Date: Dec. 14, 2017

(54) Downlink Only and Uplink/Downlink Operations On Adjacent Channels Or Same Frequency Bands

(71) Applicant: Nokia Technologies Oy, Espoo (FI)

(72) Inventors: Sari NIELSEN, Espoo (FI); Antti TOSKALA, Espoo (FI)

(21) Appl. No.: 15/531,554

(22) PCT Filed: Nov. 18, 2015
(86) PCT No.: PCT/IB2015/058942

§ 371 Date: May 30, 2017

Related U.S. Application Data
(60) Provisional application No. 62/088,845, filed on Dec. 8, 2014.

(51) Int. Cl. H04W 16/14; H04W 72/04; H04W 48/16

(52) U.S. Cl. CPC H04W 16/14; H04W 72/0446; H04W 48/16

(57) ABSTRACT

A method including scanning by a User Equipment (UE) at least one carrier frequency in a neighboring cell; determining, based upon the scanning, whether the cell is a downlink only cell or a downlink/uplink cell for the at least one carrier frequency; and based upon the determination, performing at least one of: sending a report from the UE, or starting or continuing downlink only operation on the at least one carrier frequency, or not allowing the UE to accept or start a downlink only configuration in the at least one carrier frequency.

### BACKGROUND

### Technical Field

The exemplary and non-limiting embodiments relate generally to wireless communications and, more particularly, to radio communications.

### Brief Description of Prior Developments

There are currently on-going 3GPP RAN discussions on how to enable LTE TDD operational modes. While some proponents support defining a LTE TDD downlink only mode, other proponents support defining a LTE TDD mode to have both downlink and uplink.

### SUMMARY

The following summary is merely intended to be exemplary. The summary is not intended to limit the scope of the claims.

In accordance with one aspect, an example method comprises scanning by a User Equipment (UE) at least one carrier frequency other than a currently used carrier frequency by the UE, where the scanning comprises use of a frequency not available for a network the UE is connected to; determining, based upon the scanning, whether the at least one frequency has activity, and when activity is detected whether a cell found having the at least one frequency is a downlink only cell or not; and based on the determination, reporting a result of the determination to the network for the at least one frequency.

In accordance with another aspect, an example apparatus comprises at least one processor; and at least one non-transitory memory including computer program code, the at least one memory and the computer program code configured to, with the at least one processor, cause the apparatus to: scan by the apparatus at least one carrier frequency other than a currently used carrier frequency by the apparatus, where the apparatus comprises a user equipment (UE), where the at least one carrier frequency is not available for a network the UE is connected to; determine, based upon the scanning, whether the at least one carrier frequency has activity and, when activity is detected, if a cell having the at least one carrier frequency is a downlink only cell or not; and based on the determination, reporting a result of the determination to the network regarding the at least one carrier frequency.

In accordance with another aspect, an example apparatus comprises a non-transitory program storage device readable by a machine, tangibly embodying a program of instructions executable by the machine for performing operations, the operations comprising: scanning by a User Equipment (UE) at least one carrier frequency other than a currently used carrier frequency by the UE, where the at least one carrier frequency is not available for a network the UE is connected to; determining, based upon the scanning, whether the at least one carrier frequency has activity and, when activity is detected, if a cell having the at least one carrier frequency is a downlink only cell or not; and based on the determination, reporting a result of the determination to the network regarding the at least one carrier frequency.

In accordance with another aspect, an example apparatus comprises means for scanning by the apparatus at least one carrier frequency other than a currently used carrier frequency by the apparatus, where the apparatus comprises a user equipment (UE), where the at least one carrier frequency is not available for a network the UE is connected to; means for determining, based upon the scanning, whether the at least one carrier frequency has activity and, when activity is detected, if a cell having the at least one carrier frequency is a downlink only cell or not; and means for reporting, based on the determination, a result of the determination to the network regarding the at least one carrier frequency.

In accordance with another aspect, an example method comprises scanning by a User Equipment (UE) at least one carrier frequency in a neighboring cell; determining, based upon the scanning, whether the cell is a downlink only cell or a downlink/uplink cell for the at least one carrier frequency; and based upon the determination, performing at least one of: sending a report from the UE, or starting or continuing downlink only operation on the at least one carrier frequency, or not allowing the UE to accept or start a downlink only configuration in the at least one carrier frequency.

In accordance with another aspect, an example apparatus comprises at least one processor; and at least one non-transitory memory including computer program code, the at least one memory and the computer program code configured to, with the at least one processor, cause the apparatus to: scan by a User Equipment (UE) at least one neighboring carrier frequency in a neighboring cell; determine, based upon the scan, whether the cell is a downlink only cell or a downlink/uplink cell for the at least one neighboring carrier frequency; and based upon the determination perform at least one of: send a report from the UE, or start or continue downlink only operation on the at least one neighboring carrier frequency, or not allow the UE to accept or start a downlink only configuration in the at least one neighboring carrier frequency.

In accordance with another aspect, an example embodiment is provided in a non-transitory program storage device readable by a machine, tangibly embodying a program of instructions executable by the machine for performing operations, the operations comprising: scanning by a User Equipment (UE) at least one carrier frequency in a neighboring cell; determining, based upon the scanning, whether the cell is a downlink only cell or a downlink/uplink cell for the at least one neighboring carrier frequency; and based upon the determination performing at least one of: sending a report from the UE, or starting or continuing downlink only operation on the at least one carrier frequency, or not allowing the UE to accept or start a downlink only configuration in the at least one carrier frequency.

In accordance with another aspect, an example method comprises receiving a measurement report by a base station from a User Equipment (UE), where the measurement report comprises an indication whether a neighboring cell is a downlink only cell or a downlink/uplink cell for at least one carrier frequency of the UE; based upon the indication in the measurement report, initiating a predetermined action(s) by the base station comprising not allowing use of a DL only configuration on a frequency band by at least the UE.

In accordance with another aspect, an example apparatus comprises at least one processor; and at least one non-transitory memory including computer program code, the at least one memory and the computer program code configured to, with the at least one processor, cause the apparatus to: receive a measurement report by a base station from a User Equipment (UE), where the measurement report comprises an indication whether a neighboring cell is a downlink only cell or a downlink/uplink cell for at least one carrier frequency of the UE; based upon the indication in the measurement report, initiate a predetermined action(s) by the base station comprising not allowing use of a DL only configuration on a frequency band by at least the UE.

In accordance with another aspect, an example apparatus comprises at least one processor; and at least one non-transitory memory including computer program code, the at least one memory and the computer program code configured to, with the at least one processor, cause the apparatus to: receive a measurement report by a base station from a User Equipment (UE), where the measurement report comprises an indication whether a neighboring cell is a downlink only cell or a downlink/uplink cell for at least one carrier frequency of the UE; based upon the indication in the measurement report, initiate a predetermined action(s) by the base station comprising not allowing use of a DL only configuration on a frequency band by at least the UE.

In accordance with another aspect, an example embodiment is provided in a non-transitory program storage device readable by a machine, tangibly embodying a program of instructions executable by the machine for performing operations, the operations comprising: receiving a measurement report by a base station from a User Equipment (UE), where the measurement report comprises an indication whether a neighboring cell is a downlink only cell or a downlink/uplink cell for at least one carrier frequency of the UE; based upon the indication in the measurement report, initiating a predetermined action(s) by the base station comprising not allowing use of a DL only configuration on a frequency band by at least the UE.

In accordance with another aspect, an example method comprises scanning by a User Equipment (UE) at least one carrier frequency other than a currently used carrier frequency by the UE, where the scanning comprises use of a frequency not available for a network the UE is connected to; determining, based upon the scanning, whether the at least one frequency has activity, and a TDD downlink/uplink configuration is used on the at least one carrier frequency when the activity is detected; and based on the determination, reporting a result of the determination to the network for the at least one carrier frequency.

### BRIEF DESCRIPTION OF THE DRAWINGS

The foregoing aspects and other features are explained in the following description, taken in connection with the accompanying drawings, wherein:

FIG. 1 is a diagram illustrating an example of an overall architecture of a E-UTRAN (evolved UMTS Terrestrial Radio Access) system (an air interface of 3GPP's Long Term Evolution (LTE) upgrade path for mobile networks);

FIG. 2 is a diagram illustrating some components of the wireless system shown in FIG. 1;

FIG. 3 is a diagram illustrating overlapping cells;

FIG. 4 is a diagram illustrating an example method;

FIG. 5 is a diagram illustrating conventional uplink-downlink configurations;

FIG. 6 is a diagram similar to FIG. 5, but showing a new downlink-only configuration;

FIG. 7 is a diagram illustrating an example method;

FIG. 8 is a diagram illustrating an example method; and

FIG. 9 is a diagram illustrating two networks which are at least partially neighbors.

### DETAILED DESCRIPTION OF EMBODIMENTS

The following abbreviations that may be found in the specification and/or the drawing figures are defined as follows:
3GPP Third Generation Partnership Program
4G Fourth Generation Of Mobile Telecommunications Technology, Succeeding 3G
4GPP Fourth Generation Partnership Program
AP Access Point
BB Baseband
CRC Cyclic Redundancy Check
DCI Downlink Control Information
DL Downlink
DL/UL Downlink/Uplink
DMRS Demodulation Reference Signal
DS Discovery Signal
eNB/eNodeB enhanced Node B (base station according to LTE terminology)
E-UTRAN Evolved UMTS Terrestrial Radio Access Network
ID Identity
LTE Long Term Evolution
LTE TDD Long-Term Evolution Time-Division Duplex
MIB Master information block
NCT New Carrier Type
OFDM Orthogonal Frequency Division Multiplexing
OFDMA Orthogonal Frequency Division Multiple Access
PCell Primary Cell
PDCCH Physical Downlink Control CHannel
PDSCH Physical Downlink Shared CHannel
PLMN Public Land Mobile Network
PRB Physical Resource Block
PSS Primary Synchronization Signal
RAN Radio Access Network
Rel Release
RNTI Radio Network Temporary Identifier
RRM Radio Resource Management
SCell Secondary Cell
SDL Supplemental DL
SSS Secondary Synchronization Signal
TB Transport Block
TD-LTE Time-division Long-Term Evolution
TD/TDD Time Division duplex
TL Threshold Level
UE User Equipment
UL Uplink
UMTS Universal Mobile Telecommunications System
X2 X2 is an interface used to communication between eNBs

Time-division Long-Term Evolution (TD-LTE), also referred to as Long-Term Evolution Time-Division Duplex (LTE TDD) is a 4G telecommunications technology and standard co-developed by an international coalition of companies. It is one of two variants of the Long Term Evolution (LTE) technology standard, the other being Frequency-Division Long-Term Evolution (LTE FDD).

Features as described herein may be used to provide LTE TDD operational modes including both a LTE TDD downlink only mode and a LTE TDD DL/UL mode. Features as described herein may take into consideration when a LTE TDD downlink only mode and/or a LTE TDD DL/UL mode are used on a same band on a close-by carrier, or on a neighbor frequency channel; perhaps operated by a different operator for example. Features as described herein may be used to provide LTE TDD DL only operations without creating co-existence problems for a close-by carrier and without degrading the performance of normal LTE TDD operations with both DL and UL transmissions. Features as described herein may be used to prevent co-existence problems if a LTE TDD DL only configuration and a LTE TDD DL/UL configuration were attempted to be deployed in neighboring cells on the same frequency band and especially on the adjacent frequency channels, such as by different operators for example. These channels may not always be exactly adjacent. The channels could be nearby in frequency domain. The channels could be on a same frequency band. However, the DL only and DL/UL operations may not be on the same band; but on different frequency bands which are close to each in frequency.

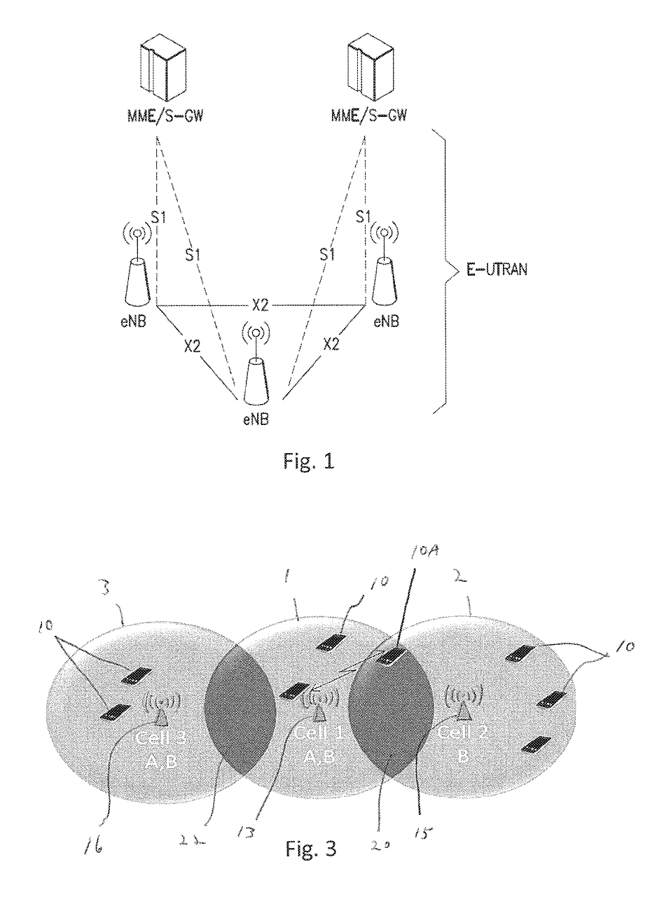

FIG. 1 shows an example of overall architecture of an E-UTRAN system. The E-UTRAN system includes eNBs, providing an E-UTRAN user plane (PDCP/RLC/MAC/PHY) and control plane (RRC) protocol terminations towards the UE (not shown in FIG. 1). The eNBs are interconnected with each other by means of an X2 interface. The eNBs are also connected by means of a S1 interface to an EPC (Enhanced Packet Core), more specifically to a MME (Mobility Management Entity) by means of a S1 MME interface and to a Serving Gateway (S-GW) by means of a S1 interface. The S1 interface supports a many-to-many relationship between MMEs/S-GW and eNBs. It should be noted that features as described herein are not limited to use with eNB base stations, and may include use of any suitable access points or nodes, such as Wifi access points for example, functioning as a base station for the UE. Thus, the term “base station” as used herein is intended to include any suitable wireless access point.

Referring also to FIG. 2, in the wireless system 230 a wireless network 235 is adapted for communication over a wireless link 232 with an apparatus, such as a mobile communication device which may be referred to as a User Equipment (UE) 10, via a network access node, such as a Node B (base station), and more specifically an eNB 13. The network 235 may include a network control element (NCE) 240 that may include MME/S-GW functionality, and which provides connectivity with a network, such as a telephone network and/or a data communications network (e.g., the internet 238).

The UE 10 includes a controller, such as a computer or a data processor (DP) 214, a computer-readable memory medium embodied as a memory (MEM) 216 that stores a program of computer instructions (PROG) 218, and a suitable wireless interface, such as radio frequency (RF) transceiver 212, for bidirectional wireless communications with the eNB 13 via one or more antennas.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The eNB 13 also includes a controller, such as a computer or a data processor (DP) 224, a computer-readable memory medium embodied as a memory (MEM) 226 that stores a program of computer instructions (PROG) 228, and a suitable wireless interface, such as RF transceiver 222, for communication with the UE 10 via one or more antennas. The eNB 13 is coupled via a data/control path 234 to the NCE 240. The path 234 may be implemented as an interface. The eNB 13 may also be coupled to another eNB via data/control path 236, which may be implemented as an interface.

The NCE 240 includes a controller, such as a computer or a data processor (DP) 244, a computer-readable memory medium embodied as a memory (MEM) 246 that stores a program of computer instructions (PROG) 248.

At least one of the PROGs 218, 228 and 248 is assumed to include program instructions that, when executed by the associated DP, enable the device to operate in accordance with exemplary embodiments of this invention, as will be discussed below in greater detail. That is, various exemplary embodiments of this invention may be implemented at least in part by computer software executable by the DP 214 of the UE 10; by the DP 224 of the eNB 13; and/or by the DP 244 of the NCE 240, or by hardware, or by a combination of software and hardware (and firmware). Base station(s) 15, 16, etc. may have the same type of components as the base station 13.

For the purposes of describing various exemplary embodiments in accordance with this invention the UE 10 and the eNB 13 may also include dedicated processors, for example RRC module 215 and a corresponding RRC module 225. RRC module 215 and RRC module 225 may be constructed so as to operate in accordance with various exemplary embodiments in accordance with this invention.

The computer readable MEMs 216, 226 and 246 may be of any type suitable to the local technical environment and may be implemented using any suitable data storage technology, such as semiconductor based memory devices, flash memory, magnetic memory devices and systems, optical memory devices and systems, fixed memory and removable memory. The DPs 214, 224 and 244 may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., RF transceivers 212 and 222) may be of any type suitable to the local technical environment and may be implemented using any suitable communication technology such as individual transmitters, receivers, transceivers or a combination of such components.

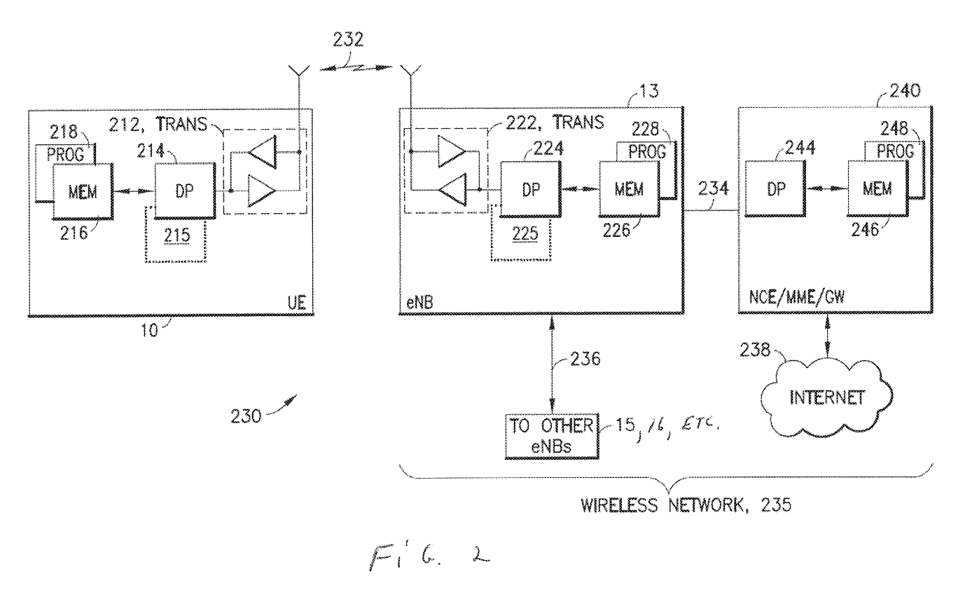

Referring also to FIG. 3, an example is shown with three base stations 13, 15, 16. However, features as described herein may be used with more or less than three base stations. The first base station 13 provides a first communication cell 1 for the UEs, for example UEs 10 and 10A in cell 1. The second base station 15 provides a second cell 2. The third base station 16 provides a third cell 3. The cells 1, 2, 3 are coverage areas for their respective base stations 13, 15, 16. Thus, a UE 10 in the first cell 1 is able to communicate with the first base station 13. Likewise, a UE 10 in the second cell 2 is able to communicate with the second base station 15, and a UE 10 in the third cell 3 is able to communicate with the third base station 16. In this example, cell 1 is configured to operate in bands A and B, cell 2 is configured to operate in band B, and cell 3 is configured to operate in bands A and B.

In this example the first and second cells 1, 2 of the first and second base stations 13, 15 have an area of overlap or shared coverage 20. The area of overlap or shared coverage 20 is, for example, a geographical area shared by two different base stations in which they can serve their users. In this example, the first and third cells 1, 3 of the first and third base stations 13, 16 also have an area of overlap or shared coverage 22. As seen by UE 10A in FIG. 3, sometimes a UE is located in an area of shared coverage 20. Sometimes no UE is located in the area of shared coverage; as illustrated in the area 22 which is empty of UEs.

The UE 10A may be connected to more than one cell at a same time. In this example the UE 10A is connected to cell 1 as a PCell having the base station 13 (such as an eNB for example) and a cell 2 as a SCell having the base station 15 (such as an eNB or WiFi Access Point for example). The two cells 1, 2 are, thus, at least partially overlapping. The PCell may operate on a licensed band and the SCell may operate on an unlicensed band. The PCell may be either a FDD cell or TDD cell for example. For simplicity, there are just one PCell and one SCell depicted in the scenario shown in FIG. 3. In other alternate examples any number of cells (PCell and SCell) operating on licensed and/or unlicensed band(s) may be provided to work together for a suitable Carrier Aggregation (CA). In one type of example embodiment the PCell and SCell may be co-located.

Features as described herein may be used in relation to an LTE-Advanced system. More specifically, features as described herein may be used on LTE operation in an unlicensed spectrum also known as Licensed-Assisted Access (LAA). The LTE LAA operation may be based on LTE Carrier Aggregation (CA). Thus, a CA primary cell (PCell) may remain on a licensed band while a secondary cell (SCell) may be on an unlicensed spectrum. Licensed-Assisted Carrier Aggregation operation may be used to aggregate a primary cell, which uses a licensed spectrum, with an at least partially overlapping secondary cell, which uses an unlicensed spectrum. In one type of example embodiment the carrier aggregation principle may assume LTE Rel-10/11/12 Carrier Aggregation scenario with co-located cells and/or non-collocated cells connected with (close to) ideal backhaul. Alternatively, in another type of example embodiment the carrier aggregation principle may assume Rel-12 Small Cell or Dual Connectivity scenario with non-collocated cells (unlicensed and licensed) and (close to) ideal or non-ideal backhaul between them. Use of the unlicensed spectrum may deliver information and guaranteed Quality of Service, to opportunistically boost data rate. The secondary cell may be used for supplemental downlink capacity only, or both downlink and uplink capacity.

According to current traffic trends in mobile networks, downlink data traffic is much larger than uplink data traffic. To accommodate the asymmetric traffic as one of the motivations, a supplemental downlink carrier has been introduced and studied for some frequency bands where unpaired spectra are available. This supplemental carrier is aimed at FDD and utilising as a Secondary Cell for Carrier Aggregation (CA). However, it has not been specified for TD-LTE although there is a great demand for such a usage for TD-LTE. Features as described herein may provide support of supplemental downlink operation for TD-LTE to accommodate the mobile traffic trend. The new DL Only configuration (configuration #7 described below) is introduced for TD-LTE, in which all the subframes are downlink. The TDD cell can be utilised as a secondary cell when the primary cell is FDD.

With features as described herein, feedback regarding the TDD UL/DL configuration of a neighboring carrier may be provided from a UE 10A to the network 235 of FIG. 2. This feedback may be as a measurement reported in the UL for a current PCell. For example, the UE 10A may be coupled with the Cell 1 as its PCell. The UE 10A may provide feedback to the base station 13 regarding the TDD UL/DL configuration of a neighboring carrier in Cell 2. When the UE 10A is using a TDD DL only configuration, also known as TDD 10:0 configuration, the TDD 10:0 capable UE 10A may identify if the neighboring carrier is, or is not, also TDD 10:0 (downlink only carrier) and may report that to the base station 13. If the UE 10A detects that a neighboring cell, for example Cell 2, has UL/DL operations on a neighboring frequency channel, the UE may report that to the base station 13. The neighboring frequency channel can be in the same frequency band such as frequency band B in Cell 2 or in a different frequency band. The UE configured for TTD DL only is able to check from a neighboring network whether the neighboring network uses DL and UL, and then report this to the Pcell of the UE's own network. This is because the neighboring network's LTE TDD DL/UL operations may be on frequency channel (with certain carrier and bandwidth), which is adjacent or nearby to the frequency channel of the UE's own network's Scell, which operates or is about to start operations in DL only mode, if no UL/DL operations are detected on any of the neighboring frequency channels.

In an example embodiment the UE 10A may be connected to a FDD or TDD PCell in another frequency band and it may be asked to provide measurement information from another band where eNodeB would consider setting up TDD operation. The UE would report back whether there are other TDD transmission close to or on the same band as the intended center frequency of the band where TDD operation is being considered. Upon reporting back to the network if TDD cells where found and what was the uplink/downlink split detected, the type of TDD operation possible may be determined by the eNodeB. The UE may report either that downlink only TDD is detected or that TDD with also uplink allocation or with existence of the special sub-frame. Additionally the timing information may be provided. The measurement may be provided for one or more detected transmissions or for the strongest one only.

In an another example embodiment the UE may be given a threshold above which level detected TDD carriers are considered; with the threshold specified in 3GPP or given as the network parameter for example. The downlink only mode of operation may be done either using TDD frame structure or with the FDD frame structure as supplemental downlink.

Features as described herein may be used to provide a technical solution for avoiding potential co-existence issues between LTE TDD DL only and LTE TDD DL/UL operations on a same frequency band and on adjacent channels. Features as described herein may be used such that it does not impact any legacy LTE TDD devices, but only requires an additional co-existence feature to be implemented in new UEs and base stations supporting LTE TDD DL only configurations and operations (also known as 10:0 configurations or supplemental LTE TDD DL only). Whenever a LTE TDD DL only capable Cell is deployed in some region or unpaired frequency requiring co-existence solutions, the UEs and base stations supporting this new DL only (10:0) TDD configuration may ensure that co-existence aspects are resolved.

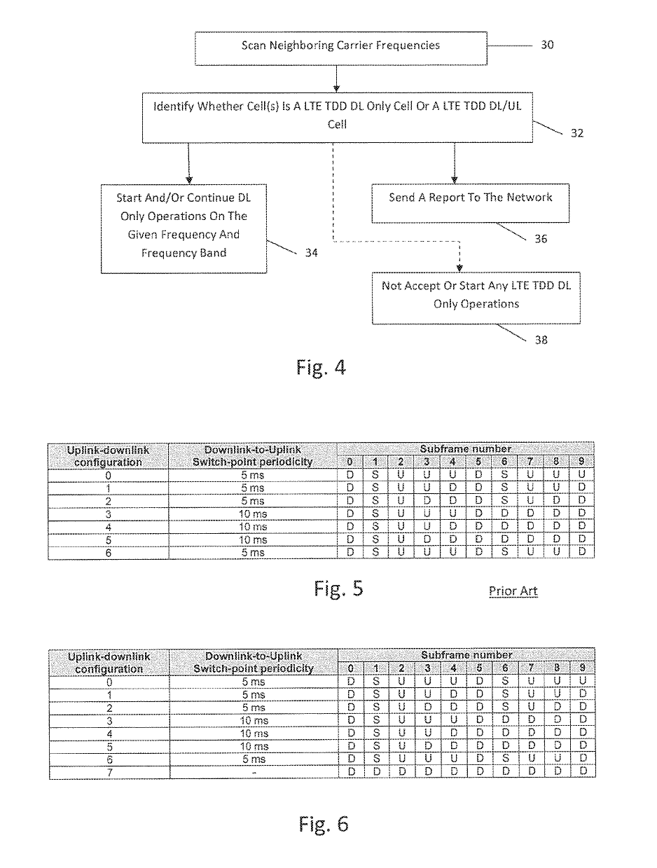

Referring also to FIG. 4, the UE 10A may scan neighboring carrier frequencies of a same frequency band as indicated by block 30 to determine if there are other LTE TDD cells deployed. The UE 10A supports LTE TDD DL only configurations and indicated or configured LTE TDD DL only cell for DL transmission, such as with an aggregated LTE FDD PCell. The UE 10A may be also capable to support LTE TDD UL/DL configurations. The scanning may be done using normal LTE Cell identification (cell search) procedures using PSS/SSS and potentially also using common reference symbols. For example, this may be on all possible carrier frequencies of the given frequency band using carrier raster defined in the specifications (3GPP TS 36.101 for UE and 3GPP TS 36.104 for base station), or may comprise only scanning the closest neighbor carrier frequencies using given carrier raster or certain given neighbor carrier(s) indicated by the base station. The specifications may define, for example, for a given frequency band how many closest neighbor carriers the UE needs to scan. For example, the UE may need to scan all possible carrier frequencies defined by the carrier raster within X MHz on both sides of the LTE TDD DL only carrier and cell. In one example embodiment the X MHz could be 20 MHz.

If the UE 10A finds LTE TDD cells on any of the scanned carrier frequencies, the UE 10A may then detect or determine whether the identified LTE TDD Cell is a DL only or a DL/UL TDD Cell as indicated by block 32. If all the identified TDD cells are DL only, the UE 10A may start and/or continue its DL only operations on the given frequency and frequency band as indicated by block 34. However, if the UE finds any LTE TDD DL/UL Cell, as indicated by block 36 the UE 10A may send a report to the network 235 of FIG. 2, which may include base station 13 of cell 1 in FIG. 3. When the network 235 received this report, the network 235 may be configured to not allow use of DL only configuration on a given frequency band and in the given geographical area. Alternatively, or additionally, in this type of situation, in order to have additional guarantee of good co-existence in all situations, the UE 10A may be configured to not accept or start any DL only operations even if a network tries to instituted a LTE TDD downlink only configuration as indicated by block 38.

FIG. 5 shows conventional uplink-downlink configurations for LTE TDD. LTE TDD uses the same frequency bands for the uplink and the downlink. The transmission directions are separated by carrying the UL and DL data in different subframes. The distribution of subframes between the transmission directions can be adapted to the data traffic and is done either symmetrically (equal number of DL and UL subframes) or asymmetrically. In this table, “D” means that DL data is transmitted in this subframe. Similarly, “U” indicates uplink data transmission and “S” specifies that the special fields DwPTS, GP and UpPTS are transmitted in this subframe.

Referring also to FIG. 6, a new uplink-downlink configuration is shown; configuration 7. Configuration 7 is a DL only configuration. The new 10:0 TDD frame structure would have easy detectable indication information that the carrier is a 10:0 type only. This also would avoid any UE trying to camp on that carrier (as no uplink is available) and also enabling the separation of current TDD carrier configurations (which all have some uplink available) and the downlink only case. Detecting that a close-by carrier also has UL (i.e. not DL only) could be potentially based only on detection by the UE 10A of the existence of a special sub-frame.

Additional ways that the UE 10A is able to find out whether the detected TDD cell is a DL/UL cell (instead of a DL only cell) may be by detecting the existence of the special sub-frame, or if that is not considered reliable enough then also having a specific additional signal/signaling could be provided. For example, there could be extra bits on L1 or even having different (modified) CRC in MIB in a DL only cell, and then the UE 10A may detect that indication.

When configured for a DL only configuration (or about to be configured a DL only configuration) the UE 10A, which supports the new uplink-downlink configuration number 7 (i.e. a DL only configuration), may be configured to detect appearance of a carrier with UL and DL transmissions on the neighboring/close-by carrier. In other words, the UE 10A may be configured to detect appearance of a carrier which supports only the other configurations 1-6 and does not support configuration 7 with DL only transmission.

The UE 10A may be requested by the base station 13 to check the neighboring or nearby carriers on both side of DL only cell, or even all other carriers on a given band for potential DL/UL configurations before the base station can start DL only operations on a given carrier. The UE itself may initiate the checking. The UE may be configured to do this type of check (detection) of potential UL/DL carriers on adjacent or nearby carriers regularly after DL operations have been started in order to check for potential changes of DL/UL configurations on other channels on the same frequency band. In this way, one can ensure good co-existence between DL only and DL/UL cells on neighboring carriers in all situations and areas; even when the UE 10A moves to another geographical area. The UE may trigger measurement reports for the base station using a PCell (different from DL only cell) when it detects that there is a cell using one of the configurations with both DL and UL transmission on one of the neighboring or close-by carriers to indicated or configured DL only cell.

The UE measurement report could also contain information of the frame timing, center frequency, and possibly the uplink-downlink configuration of a nearby carrier with DL/UL configuration and transmission, channel quality, etc.

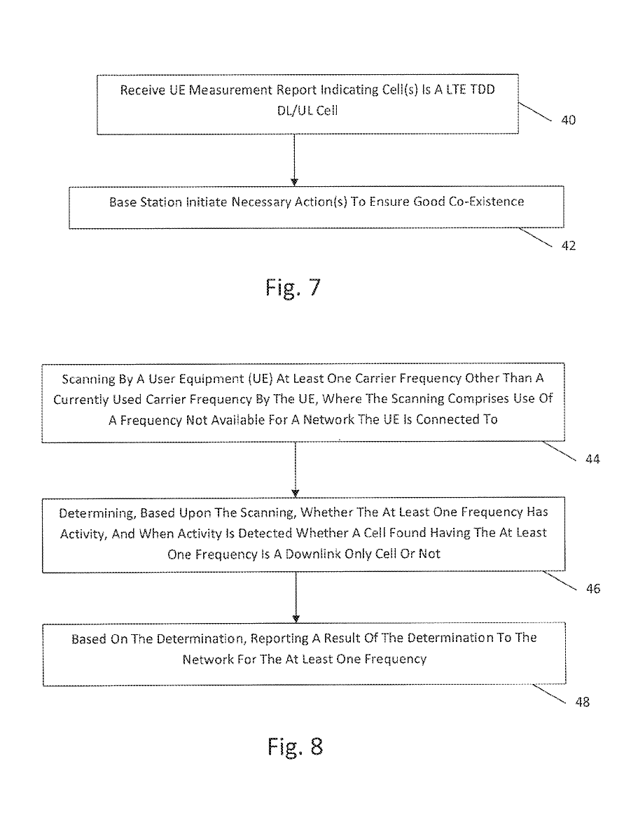

Referring also to FIG. 7, the base station 13 is configured to receive the measurement report from the UE 10A as indicated by block 40. Based upon the UE measurement report, the base station may initiate necessary action(s) (change of configuration, use of DTX for part of the sub-frames, etc. . . . ) as indicated by block 42. However, specifications may set some requirements or constraints to the base station. For example, a specification may indicate that the base station is not allowed to use DL only configuration 7 when one of the carriers, close to the DL only carrier, is used for DL/UL operations, such as by a neighboring operator for example. This ensures good co-existence even between different operators in all situations.

Features as described herein relate to the on-going 3GPP RAN discussion on how to enable LTE TDD downlink only operations on unpaired LTE TDD frequency band. Features as described herein provide the possibility for the case where there could be a normal LTE TDD operations with both DL and UL transmissions on an adjacent or close-by frequency channel or carrier on the same band or on a neighboring frequency channel or carrier on a different band, wherein the frequency band may be operated by one operator or different operators. This neighboring carrier (adjacent or nearby in frequency) is typically on the same frequency band, but could also be on a different frequency band, which are next to each other. This allows for some operators to use a TDD downlink only mode while other TDD operators may use both downlink and uplink in the band.

Features as described herein help to overcome the concerns expressed by some companies/operators that LTE TDD DL only operations could create co-existence problems for close by carriers and degrade the performance of normal LTE TDD operations with both DL and UL transmissions if LTE TDD DL only and LTE TDD DL/UL Cells are deployed on the same frequency band and especially on the adjacent frequency channels e.g. by different operators. Features as described herein provide a technical solution for avoiding any potential co-existence issues between LTE TDD DL only operations and normal LTE TDD DL/UL operations on neighboring frequency channels on the same frequency band.

An example method may comprise scanning by a User Equipment (UE) at least one carrier frequency in a neighboring cell; determining, based upon the scanning, whether the cell is a downlink only cell or a downlink/uplink cell for the at least one neighboring carrier frequency; and based upon the determination, performing at least one of: sending a report from the UE, or starting or continuing downlink only operation on the at least one carrier frequency, or not allowing the UE to accept or start a downlink only configuration in the at least one carrier frequency.

An example embodiment may be provided in an apparatus comprising at least one processor; and at least one non-transitory memory including computer program code, the at least one memory and the computer program code configured to, with the at least one processor, cause the apparatus to: scan by a User Equipment (UE) at least one carrier frequency in a neighboring cell; determine, based upon the scan, whether the cell is a downlink only cell or a downlink/uplink cell for the at least one neighboring carrier frequency; and based upon the determination, perform at least one of: send a report from the UE, or starting or continuing downlink only operation on the at least one carrier frequency, or not allow the UE to accept or start a downlink only configuration in the at least one carrier frequency. The determination of whether the cell is downlink only may be based considering cells only that have signal strength over a particular threshold. This threshold may be defined to be dependent if the carrier is adjacent carrier or located further away in the band.

An example embodiment may be provided in a non-transitory program storage device, such as 216 for example, readable by a machine, tangibly embodying a program of instructions executable by the machine for performing operations, the operations comprising: scanning by a User Equipment (UE) at least one carrier frequency in a neighboring cell; determining, based upon the scanning, whether the cell is a downlink only cell or a downlink/uplink cell for the at least one neighboring carrier frequency; and based upon the determination, performing at least one of: sending a report from the UE, or starting or continuing downlink only operation on the at least one carrier frequency, or not allowing the UE to accept or start a downlink only configuration in the at least one carrier frequency.

Any combination of one or more computer readable medium(s) may be utilized as the memory. The computer readable medium may be a computer readable signal medium or a non-transitory computer readable storage medium. A non-transitory computer readable storage medium does not include propagating signals and may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

An example method may comprise receiving a measurement report by a base station from a User Equipment (UE), where the measurement report comprises an indication whether a neighboring cell is a downlink only cell or a downlink/uplink cell for at least one carrier frequency of the UE; based upon the indication in the measurement report, initiating a predetermined action(s) by the base station comprising not allowing use of a DL only configuration on a frequency band by at least the UE. In one example, the UE measurement report may be only sent if DL/UL operations on one of the scanned frequencies is detected.

An example embodiment may be provided in an apparatus comprising at least one processor; and at least one non-transitory memory including computer program code, the at least one memory and the computer program code configured to, with the at least one processor, cause the apparatus to: receive a measurement report by a base station from a User Equipment (UE), where the measurement report comprises an indication whether a neighboring cell is a downlink only cell or a downlink/uplink cell for at least one carrier frequency of the UE; based upon the indication in the measurement report, initiate a predetermined action(s) by the base station comprising not allowing use of a DL only configuration on a frequency band by at least the UE.

An example embodiment may be provided in a non-transitory program storage device, such as 226 for example, readable by a machine, tangibly embodying a program of instructions executable by the machine for performing operations, the operations comprising: receiving a measurement report by a base station from a User Equipment (UE), where the measurement report comprises an indication whether a neighboring cell is a downlink only cell or a downlink/uplink cell for at least one carrier frequency of the UE; based upon the indication in the measurement report, initiating a predetermined action(s) by the base station comprising not allowing use of a DL only configuration on a frequency band by at least the UE.

An example embodiment may be provided in an apparatus comprising means for scanning by a User Equipment (UE) at least one carrier frequency in a neighboring cell; means for determining, based upon the scanning, whether the cell is a downlink only cell or a downlink/uplink cell for the at least one neighboring carrier frequency; and based upon the determination, means for performing at least one of: sending a report from the UE, or starting or continuing downlink only operation on the at least one carrier frequency, or not allowing the UE to accept or start a downlink only configuration in the at least one carrier frequency.

TDD DL only operations may be provided on some frequency bands in addition to TDD DL/UL operations on some other frequencies and/or other regions and operators. Operators with large FDD networks may utilize their unpaired spectrum by aggregation FDD and TDD DL only instead of needing to build whole TDD DL/UL networks for utilizing their unpair spectrum. Devices may support both DL only and DL/UL operations in the same device. However, for some bands the UE may only have DL only support.

The UE may scan the same frequency and neighboring frequency(ies) in a neighbor cell. The fear is that a DL only operation might degrade the performance of another network with DL/UL operations (in the neighboring cell) if they are in close proximity in frequency and geographically. The co-existence mechanisms described herein have not been described for investigating a UE's own network, but only a potential victim network with DL/UL operations (in a neighboring cell). However, in the future, features as described herein may be adapted for the UE to scan neighboring carrier frequency of its own cell; to see whether that particular frequency is used for TDD DL only. These frequencies could overlap as operators are always allocated their own frequency block (i.e. licensed band) and operators are not required to share the spectrum with each other.

With features as described herein, the UE can scan at least one other carrier frequency; a carrier frequency other than the carrier frequency of its own network. The UE may need to search other frequency or frequencies blindly from neighboring carriers. Alternatively, or additionally, the UE may search other frequency(ies) based upon some specific information from the specification or using signaling. At the point of time of the scan, the UE may not know whether the at least one other carrier frequency is empty, or whether the at least one other carrier frequency is even in a neighboring cell. However, the at least one other carrier frequency would not belong the UE's own network/cell. The carrier frequency(ies) which the UE needs to scan are not too far from each other (in frequency). If these channels (carriers) are very far from each other in frequency, there would not be any interference and no co-existence problem. As discussed herein, currently operators do not need to share the same spectrum and, therefore, it is not necessary for the UE to scan its own carrier frequency where its own network operates. However, if in the future operators do share the same spectrum, then features as described herein may be used by the UE in its own cell.

Referring also to FIG. 8, an example method may comprise scanning by a User Equipment (UE) at least one carrier frequency other than a currently used carrier frequency by the UE as indicated by block 44, where the scanning comprises use of a frequency not available for a network the UE is connected to; determining, based upon the scanning, whether the at least one frequency has activity, and when the activity is detected or determined whether a cell found having the at least one frequency is a downlink only cell or not as indicated by block 46; and based on the determination, reporting a result of the determination to the network for the at least one frequency as indicated by block 48.

The detection may comprise the UE detecting whether a neighbor frequency channel and detected TDD Cell on that channel has a DL/UL configuration in use (instead of checking whether it is DL only channel). In this example the UE would be only requested to check whether it finds cells with DL/UL operations on any of the neighboring frequency channels and, if so, then take some action, such as a measurement report to the network or not using its own network DL only carrier (e.g. as Scell) for example. If no DL/UL operations are detected, the UE is not required to do any such action.

The determination may include measurement of a frame timing of carrier frequency detected having activity. The UE may decline use of downlink only configuration if a close-by frequency is found not to be having downlink only configuration. In some circumstances, if a UE detects or determines another TDD cell using DL/UL operations on a neighboring or close-by frequency and itself should or is intended to be used for downlink only operations, the UE should not use or may decline use of downlink only configuration. In some other circumstances, if the UE does not detect any TDD network, it may operate in the downlink only mode or operations. The decline may happen if the UE has detected another TDD, but it uses DL/UL operations and the UE should use DL only operations on its own network unpaired carrier frequency used or intended to be used for DL only operations. However, if the UE does not find any TDD network, it naturally may operate on DL only mode. Thus, the UE may detect whether DL/UL operations are in use in a neighboring frequency channel and, if so, then the UE does not operate in DL only mode.

With features as described herein, the 10:0 configuration can be configured as a Secondary Cell when a UE is configured with CA. Under the network where one of the existing TDD UL-DL configurations is configured, the UE should be able to connect to the TDD network using the configuration.

An example embodiment may be provided in an apparatus comprising at least one processor; and at least one non-transitory memory including computer program code, the at least one memory and the computer program code configured to, with the at least one processor, cause the apparatus to: scan by a User Equipment (UE) at least one carrier frequency other than a currently used carrier frequency by the UE, where the scanning comprises use of a frequency not available for a network the UE is connected to; determine, based upon the scanning, whether the at least one frequency has activity, and when activity is detected or determined whether a cell found having the at least one frequency is a downlink only cell or not; and based on the determination, report a result of the determination to the network for the at least one frequency.

An example embodiment may be provided in an apparatus comprising means for scanning by a User Equipment (UE) at least one carrier frequency other than a currently used carrier frequency by the UE, where the scanning comprises use of a frequency not available for a network the UE is connected to; means for determining, based upon the scanning, whether the at least one frequency has activity, and when activity is detected or determined whether a cell found having the at least one frequency is a downlink only cell or not; and based on the determination, means for reporting a result of the determination to the network for the at least one frequency.

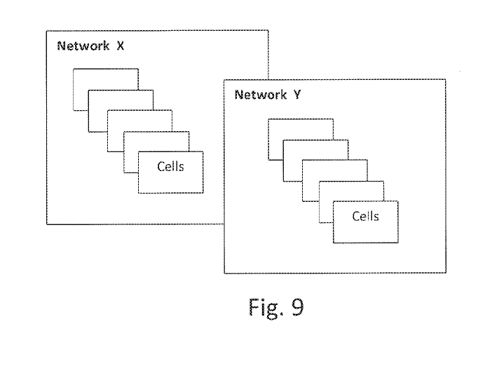

As seen with reference to FIG. 9, this figure helps to illustrate that one network X with certain cells and UEs, operating on frequency channel X (i.e. with certain carrier frequency and channel bandwidth) of frequency band A, and another network Y with cells and UEs in the neighborhood operating on frequency channel Y of frequency band A. These channels X and Y are then adjacent to each other and, therefore, co-existence issues could occur even when operating on DL only mode and another DL/UL mode.

An example method may comprising scanning by a User Equipment (UE) at least one carrier frequency other than a currently used carrier frequency by the UE, where the scanning comprises use of a frequency not available for a network the UE is connected to; determining, based upon the scanning, whether the at least one frequency has activity, and a TDD downlink/uplink configuration is used on the at least one carrier frequency when the activity is detected; and based on the determination, reporting a result of the determination to the network for the at least one carrier frequency.

An example embodiment may be provided in an apparatus comprising at least one processor; and at least one non-transitory memory including computer program code, the at least one memory and the computer program code configured to, with the at least one processor, cause the apparatus to: scan by a User Equipment (UE) at least one carrier frequency other than a currently used carrier frequency by the UE, where the scanning comprises use of a frequency not available for a network the UE is connected to; determine, based upon the scanning, whether the at least one frequency has activity, and a TDD downlink/uplink configuration is used on the at least one carrier frequency when the activity is detected; and based on the determination, report a result of the determination to the network for the at least one carrier frequency

An example embodiment may be provided in an apparatus comprising means for scanning by a User Equipment (UE) at least one carrier frequency other than a currently used carrier frequency by the UE, where the scanning comprises use of a frequency not available for a network the UE is connected to; means for determining, based upon the scanning, whether the at least one frequency has activity, and a TDD downlink/uplink configuration is used on the at least one carrier frequency when the activity is detected; and means for reporting a result of the determination to the network for the at least one carrier frequency based on the determination.

In one type of example method, the method may comprise scanning by a User Equipment (UE) at least one carrier frequency other than a currently used carrier frequency by the UE, where the at least one carrier frequency is not available for a network the UE is connected to; determining, based upon the scanning, whether the at least one carrier frequency has activity and, when activity is detected, if a cell having the at least one carrier frequency is a downlink only cell or not; and based on the determination, reporting a result of the determination to the network regarding the at least one carrier frequency.

The determination may include measurement of a frame timing of carrier frequency detected having activity. The method may further comprise declining use of a downlink only configuration when the at least one carrier frequency is found not to have a downlink only configuration. The declining of the use of the downlink only configuration may be done by the UE. The method may further comprise, based on the determination, starting or continuing a downlink only operation on the at least one carrier frequency. The method may further comprise, based on the determination, not allowing the UE to accept or start a downlink only configuration in the at least one carrier frequency.

An example embodiment may be provided in an apparatus comprising at least one processor; and at least one non-transitory memory including computer program code, the at least one memory and the computer program code configured to, with the at least one processor, cause the apparatus to: scan by the apparatus at least one carrier frequency other than a currently used carrier frequency by the apparatus, where the apparatus comprises a user equipment (UE), where the at least one carrier frequency is not available for a network the UE is connected to; determine, based upon the scanning, whether the at least one carrier frequency has activity and, when activity is detected, if a cell having the at least one carrier frequency is a downlink only cell or not; and based on the determination, reporting a result of the determination to the network regarding the at least one carrier frequency.

The determination may include measurement of a frame timing of carrier frequency detected having activity. The at least one memory and the computer program code may be configured to, with the at least one processor, cause the apparatus to decline use of a downlink only configuration when the at least one carrier frequency is found not to have a downlink only configuration. The declining of the use of the downlink only configuration may be done by the UE. The at least one memory and the computer program code may be configured to, with the at least one processor, cause the apparatus to: based on the determination, start or continue a downlink only operation on the at least one carrier frequency. The at least one memory and the computer program code may be configured to, with the at least one processor, cause the apparatus to: based on the determination, not allow the UE to accept or start a downlink only configuration in the at least one carrier frequency.

An example embodiment may be provided in a non-transitory program storage device readable by a machine, tangibly embodying a program of instructions executable by the machine for performing operations, the operations comprising: scanning by a User Equipment (UE) at least one carrier frequency other than a currently used carrier frequency by the UE, where the at least one carrier frequency is not available for a network the UE is connected to; determining, based upon the scanning, whether the at least one carrier frequency has activity and, when activity is detected, if a cell having the at least one carrier frequency is a downlink only cell or not; and based on the determination, reporting a result of the determination to the network regarding the at least one carrier frequency.

An example embodiment may be provided in an apparatus comprising: means for scanning by the apparatus at least one carrier frequency other than a currently used carrier frequency by the apparatus, where the apparatus comprises a user equipment (UE), where the at least one carrier frequency is not available for a network the UE is connected to; means for determining, based upon the scanning, whether the at least one carrier frequency has activity and, when activity is detected, if a cell having the at least one carrier frequency is a downlink only cell or not; and means for reporting, based on the determination, a result of the determination to the network regarding the at least one carrier frequency.

An example method may comprise scanning by a User Equipment (UE) at least one carrier frequency in a neighboring cell; determining, based upon the scanning, whether the neighboring cell is a downlink only cell or a downlink/uplink cell for the at least one carrier frequency; and based upon the determination, performing at least one of: sending a report from the UE, starting or continuing downlink only operation on the at least one carrier frequency, and not allowing the UE to accept or start a downlink only configuration in the at least one carrier frequency. The performing may be based, at least partially, upon a determination from the scanning whether the at least one carrier frequency has activity.

An example embodiment may be provided in an apparatus comprising: at least one processor; and at least one non-transitory memory including computer program code, the at least one memory and the computer program code configured to, with the at least one processor, cause the apparatus to: scan by the apparatus at least one neighboring carrier frequency in a neighboring cell, where the apparatus comprises a User Equipment (UE); determine, based upon the scan, whether the neighboring cell is a downlink only cell or a downlink/uplink cell for the at least one neighboring carrier frequency; and based upon the determination, perform at least one of: send a report from the UE, start or continue downlink only operation on the at least one neighboring carrier frequency, and not allow the UE to accept or start a downlink only configuration in the at least one neighboring carrier frequency. The performing may be based, at least partially, upon a determination from the scan whether the at least one carrier frequency has activity.

An example embodiment may be provided in a non-transitory program storage device readable by a machine, tangibly embodying a program of instructions executable by the machine for performing operations, the operations comprising: scanning by a User Equipment (UE) at least one carrier frequency in a neighboring cell; determining, based upon the scanning, whether the neighboring cell is a downlink only cell or a downlink/uplink cell for the at least one carrier frequency; and based upon the determination, performing at least one of: sending a report from the UE, starting or continuing downlink only operation on the at least one carrier frequency, and not allowing the UE to accept or start a downlink only configuration in the at least one carrier frequency.

An example method may comprise receiving a measurement report by a base station from a User Equipment (UE), where the measurement report comprises an indication whether a neighboring cell is a downlink only cell or a downlink/uplink cell for at least one carrier frequency; based upon the indication in the measurement report, initiating a predetermined action(s) by the base station comprising not allowing use of a downlink only configuration on a frequency band by at least the UE.

An example embodiment may be provided in an apparatus comprising: at least one processor; and at least one non-transitory memory including computer program code, the at least one memory and the computer program code configured to, with the at least one processor, cause the apparatus to: receive a measurement report by the apparatus from a User Equipment (UE), where the apparatus comprises a base station, where the measurement report comprises an indication whether a neighboring cell is a downlink only cell or a downlink/uplink cell for at least one carrier frequency; based upon the indication in the measurement report, initiate a predetermined action(s) by the base station comprising not allowing use of a downlink only configuration on a frequency band by at least the UE.

An example embodiment may be provided in a non-transitory program storage device readable by a machine, tangibly embodying a program of instructions executable by the machine for performing operations, the operations comprising: receiving a measurement report by a base station from a User Equipment (UE), where the measurement report comprises an indication whether a neighboring cell is a downlink only cell or a downlink/uplink cell for at least one carrier frequency; based upon the indication in the measurement report, initiating a predetermined action(s) by the base station comprising not allowing use of a downlink only configuration on a frequency band by at least the UE.

An example method may comprise scanning by a User Equipment (UE) at least one carrier frequency other than a currently used carrier frequency by the UE, where the at least one carrier frequency is not available for a network the UE is connected to; determining, based upon the scanning, whether the at least one carrier frequency is being used with a TDD downlink/uplink configuration; and based on the determining, reporting a result to the network. The determining may comprise measurement of a frame timing of the at least one carrier frequency. The method may further comprise declining use of downlink only configuration based on the determining.

An example embodiment may be provided in an apparatus comprising at least one processor; and at least one non-transitory memory including computer program code, the at least one memory and the computer program code configured to, with the at least one processor, cause the apparatus to: scan by the apparatus at least one carrier frequency other than a currently used carrier frequency by the UE, where the apparatus comprises a user equipment (UE), where the at least one carrier frequency is not available for a network the UE is connected to; determine, based upon the scan, whether the at least one carrier frequency is being used with a TDD downlink/uplink configuration; and based on the determination, report a result to the network.

An example embodiment may be provided in a non-transitory program storage device readable by a machine, tangibly embodying a program of instructions executable by the machine for performing operations, the operations comprising: scanning by a User Equipment (UE) at least one carrier frequency other than a currently used carrier frequency by the UE, where the at least one carrier frequency is not available for a network the UE is connected to; determining, based upon the scanning, whether the at least one carrier frequency is being used with a TDD downlink/uplink configuration; and based on the determining, reporting a result to the network.

An example embodiment may be provided in an apparatus comprising: means for scanning by a User Equipment (UE) at least one carrier frequency, where the at least one carrier frequency is not available for a network the UE is connected to; means for determining, based upon the scanning, whether the at least one carrier frequency is being used with a TDD downlink/uplink configuration; and means for reporting, based on the determining, a result to the network.

An example embodiment may be provided in an apparatus comprising: means for receiving a measurement report by the apparatus from a User Equipment (UE), where the apparatus comprises a base station, where the measurement report comprises an indication whether a neighboring cell is a downlink only cell or a downlink/uplink cell for at least one carrier frequency; means for initiating, based upon the indication in the measurement report, a predetermined action(s) by the base station comprising not allowing use of a downlink only configuration on a frequency band by at least the UE.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1-29. (canceled)

30. A method comprising:
scanning by a User Equipment (UE) at least one carrier frequency other than a currently used carrier frequency by the UE, where the at least one carrier frequency is not available for a network the UE is connected to;
determining, based upon the scanning, whether the at least one carrier frequency has activity and, when activity is detected, if a cell having the at least one carrier frequency is a downlink only cell or not; and
based on the determination, reporting a result of the determination to the network regarding the at least one carrier frequency.

31. A method as in claim 30, wherein the determination includes measurement of a frame timing of carrier frequency detected having activity.

32. A method as in claim 30, further comprising declining use of a downlink only configuration when the at least one carrier frequency is found not to have a downlink only configuration.

33. A method as in claim 32 where the declining of the use of the downlink only configuration is done by the UE.

34. A method as in claim 30 further comprising, based on the determination, starting or continuing a downlink only operation on the at least one carrier frequency.

35. A method as in claim 30 further comprising, based on the determination, not allowing the UE to accept or start a downlink only configuration in the at least one carrier frequency.

36. An apparatus comprising:
at least one processor; and
at least one non-transitory memory including computer program code, the at least one memory and the computer program code configured to, with the at least one processor, cause the apparatus to:
scan at least one carrier frequency other than a currently used carrier frequency by the apparatus, where the apparatus comprises a user equipment (UE), where the at least one carrier frequency is not available for a network the UE is connected to;
determine, based upon the scanning, whether the at least one carrier frequency has activity and, when activity is detected, if a cell having the at least one carrier frequency is a downlink only cell or not; and
based on the determination, reporting a result of the determination to the network regarding the at least one carrier frequency.

37. An apparatus as in claim 36 wherein the determination includes measurement of a frame timing of carrier frequency detected having activity.

38. An apparatus as in claim 36 where the at least one memory and the computer program code are configured to, with the at least one processor, cause the apparatus to decline use of a downlink only configuration when the at least one carrier frequency is found not to have a downlink only configuration.

39. An apparatus as in claim 38 where the declining of the use of the downlink only configuration is done by the UE.

40. An apparatus as in claim 36 where the at least one memory and the computer program code are configured to, with the at least one processor, cause the apparatus to:
based on the determination, start or continue a downlink only operation on the at least one carrier frequency.

41. An apparatus as in claim 36 where the at least one memory and the computer program code are configured to, with the at least one processor, cause the apparatus to:
based on the determination, not allow the UE to accept or start a downlink only configuration in the at least one carrier frequency.

42. An apparatus comprising:
at least one processor; and
at least one non-transitory memory including computer program code, the at least one memory and the computer program code configured to, with the at least one processor, cause the apparatus to:
scan at least one neighboring carrier frequency in a neighboring cell, where the apparatus comprises a User Equipment (UE);
determine, based upon the scan, whether the neighboring cell is a downlink only cell or a downlink/uplink cell for the at least one neighboring carrier frequency; and
based upon the determination, perform at least one of:
send a report from the UE,
start or continue downlink only operation on the at least one neighboring carrier frequency, and
not allow the UE to accept or start a downlink only configuration in the at least one neighboring carrier frequency.

43. An apparatus as in claim 42 where the performing is based, at least partially, upon a determination from the scan whether the at least one carrier frequency has activity.

44. An apparatus comprising:
at least one processor; and
at least one non-transitory memory including computer program code, the at least one memory and the computer program code configured to, with the at least one processor, cause the apparatus to:
scan by the apparatus at least one carrier frequency other than a currently used carrier frequency by the UE, where the apparatus comprises a user equipment (UE), where the at least one carrier frequency is not available for a network the UE is connected to;
determine, based upon the scan, whether the at least one carrier frequency is being used with a TDD downlink/uplink configuration; and
based on the determination, report a result to the network.

45. An apparatus as in claim 44 where the determination comprises measurement of a frame timing of the at least one carrier frequency.

46. An apparatus as in claim 44 where the at least one memory and the computer program code are configured to, with the at least one processor, cause the apparatus to decline use of downlink only configuration based on the determination.
